(19) United States
(12) Patent Application Publication
(10) Pub. No.: US 2024/0116420 A1
(43) Pub. Date: Apr. 11, 2024

(54) ARMREST ARRANGEMENT, SUBASSEMBLY AND VEHICLE SEAT STRUCTURE

(71) Applicant: BOS GmbH & Co. KG, Ostfildern (DE)

(72) Inventor: Andreas GÖBBELS, Kürten (DE)

(21) Appl. No.: 18/469,835

(22) Filed: Sep. 19, 2023

(30) Foreign Application Priority Data
Sep. 30, 2022 (DE) 102022210402.1

(51) Int. Cl. B60N 2/75; B60N 2/90

(52) U.S. Cl. CPC B60N 2/753; B60N 2/938; B60N 2002/952

(57) ABSTRACT

An armrest arrangement for a vehicle seat structure including a supporting structure and a profiled shaft both fixed to the vehicle, an armrest body with a carrier structure, and a bearing device. The armrest body is mounted by the bearing device on the profiled shaft so as to be pivotably movable relative to the supporting structure about a longitudinal axis of the profiled shaft between a resting position and a supporting position. The carrier structure is held on the bearing device so as to be pivotably movable about the longitudinal axis, and a free end portion of the profiled shaft has a rotationally asymmetrical cross section. The bearing device is axially positioned on the free end portion such that the bearing device is positively connected to the profiled shaft about the longitudinal axis.

### CROSS-REFERENCE TO RELATED APPLICATION

This claims priority from German Application No. 10 2022 210 402.1 filed Sep. 30, 2022, the disclosure of which is hereby incorporated by reference in its entirety.

### TECHNICAL FIELD

The invention relates to an armrest arrangement for a vehicle seat structure having a supporting structure which is fixed to the vehicle in the mounted state and which has a profiled shaft which is fixed to the vehicle in the mounted state, an armrest body with a carrier structure, and a bearing device, the armrest body being mounted by the bearing device on the profiled shaft so as to be pivotably movable relative to the supporting structure about a longitudinal axis of the profiled shaft between a resting position and a supporting position. The invention further relates to a subassembly for such an armrest arrangement, wherein the subassembly has an armrest body with a carrier structure, and a bearing device, the armrest body being mounted by the bearing device on a profiled shaft so as to be pivotably movable about a longitudinal axis of the profiled shaft between a resting position and a supporting position. The invention also relates to a vehicle seat structure including such an armrest arrangement.

### BACKGROUND AND SUMMARY

An armrest arrangement for a vehicle seat structure is disclosed in DE 10 2018 213 763 A1. The disclosed armrest arrangement has a supporting structure which is fixed to the vehicle in the mounted state and which comprises a profiled shaft which is fixed to the vehicle in the mounted state. Additionally, the disclosed armrest arrangement has an armrest body with a carrier structure and a bearing device, wherein the armrest body is mounted on the profiled shaft by means of the bearing device so as to be pivotably movable relative to the supporting structure about a longitudinal axis of the profiled shaft between a resting position and a supporting position. The disclosed armrest arrangement is provided for a central armrest which is arranged between two seats of a vehicle seat structure which is configured as a seat bench. In the mounted state, the profiled shaft is covered at both ends by the vehicle seat structure.

An aspect of the invention to provide an armrest arrangement, a subassembly and a vehicle seat structure of the type mentioned in the introduction which permit a simplified mounting.

For the armrest arrangement, this is achieved by the carrier structure being held, in particular axially, on the bearing device so as to be pivotably movable about the longitudinal axis, and by a free end portion of the profiled shaft having a rotationally asymmetrical, in particular polygonal, cross section, and by the bearing device being axially positioned on the free end portion such that the bearing device is positively connected to the profiled shaft about the longitudinal axis. The bearing device can be connected in an axially releasable manner to the profiled shaft on one side. Thus the bearing device can be removed from the profiled shaft along the longitudinal axis, for example for maintenance purposes, or positioned on the profiled shaft from one side for the assembly of the armrest arrangement. This results in a particularly simple mounting. In particular, the bearing device can be axially removed from the profiled shaft without the supporting structure having to be dismantled from the vehicle and/or without any other components of the armrest arrangement having to be removed. In the mounted state of the supporting structure, the free end of the profiled shaft is preferably free, i.e. it protrudes axially outwardly with a blind terminus. Axially opposing the free end, the supporting structure can be fastened or is fastened to a structural part.

Unless specified otherwise, in the present context the terms “axial” and “radial” refer to the longitudinal axis of the profiled shaft. “Radial” can mean “perpendicular to the longitudinal axis”. “Axial” can mean “along the longitudinal axis”.

In one embodiment, the bearing device can be premounted on the armrest body, in particular on the carrier structure. In the premounted state, the bearing device together with the armrest body can be positioned on the free end portion or can be removed from the free end portion. Advantageously, therefore, it is possible to provide a subassembly consisting of the armrest body and the bearing device premounted thereon. This results in a particularly simple assembly of the armrest arrangement. Additionally, the entire subassembly can be replaced in a particularly simple manner, for example for maintenance purposes, in particular without the supporting structure having to be dismantled from the vehicle for this purpose.

In a further embodiment, the bearing device has a rotary stop element which is positively positioned on the free end portion of the profiled shaft about the longitudinal axis, wherein the armrest body has a stop device which is adjustable, in particular, relative to the carrier structure, wherein the stop device bears against the rotary stop element in the supporting position. Such an armrest arrangement proves to be particularly robust. The supporting position can be ergonomically adapted due to the adjustable stop device.

In a further embodiment, the bearing device has at least one, in particular sleeve-shaped, bearing piece which is positively positioned on the free end portion of the profiled shaft about the longitudinal axis, wherein the carrier structure has for each bearing piece a bearing opening in which the bearing piece is received so as to be rotatably movable relative to the carrier structure, in particular wherein the bearing piece has a radially protruding shoulder which forms an axial stop for the carrier structure. This permits a particularly reliable bearing of the carrier structure.

In a further embodiment, two bearing pieces are present, the bearing pieces on both sides of a rotary stop element of the bearing device being positively positioned on the free end portion of the profiled shaft so as to be fixed in terms of rotation, in particular wherein at least one of the bearing pieces and/or the rotary stop element has a positioning aid for orienting the at least one bearing piece and the rotary stop element relative to one another. Such a multi-part bearing device proves particularly simple to mount. In particular for maintenance purposes, it is possible to change only one of the aforementioned components, instead of having to replace the entire bearing device. The positioning aid can ensure a correct rotational orientation of the bearing pieces and the rotary stop element relative to the longitudinal axis.

In a further embodiment, the bearing device is releasably held on the carrier structure axially and radially relative to the longitudinal axis by means of a fastening device of the armrest arrangement, wherein—alternatively or additionally—the bearing device is releasably held axially on the profiled shaft by means of the, in particular by means of the same, fastening device. It can be advantageously ensured by means of the fastening device that the components which are held against one another are not inadvertently released. If only a single fastening device is used for fulfilling the above functions, this advantageously results in a particularly small number of parts. This can have an advantageous effect on a mounting effort.

In a further embodiment, the fastening device has a resiliently deformable pretensioning element, wherein the free end portion has an engagement contour and wherein an engagement portion of the pretensioning element, which is resiliently deflectable transversely to the longitudinal axis, engages in the engagement contour, in particular in the manner of a snap hook, in order to hold the bearing device releasably on the profiled shaft along the longitudinal axis, in particular wherein the engagement portion protrudes through the engagement contour into a profile interior of the profiled shaft. The engagement contour can be radially recessed. Preferably, when the bearing device is positioned on the profiled shaft the resiliently deflectable engagement portion is automatically deflected in order to be latched to the engagement contour as soon as the engagement contour is aligned, in particular radially, with the engagement portion. A manual actuation of the fastening device is thus not required for the fastening.

In a further embodiment, a profile interior of the profiled shaft is accessible on the front face along the longitudinal axis, in particular in order to release a connection between the bearing device and the profiled shaft from the outside. “From the outside” is understood to mean that, for releasing the connection, a tool can be guided into the profile interior from the external surroundings of the profiled shaft through an opening of the profiled shaft on the front face. This permits a particularly simple dismantling of the bearing device together with the carrier structure from the profiled shaft, wherein the bearing device can preferably remain in its premounted state on the carrier structure. The armrest body can have a cover which is releasably fastened to the carrier structure in order to cover the profiled shaft on the front face. This cover can be removed from the carrier structure for releasing the connection from the outside.

In a further embodiment, the armrest arrangement has a friction ring which is arranged, in particular clamped, along the longitudinal axis between the carrier structure and the bearing device. Advantageously, a defined friction can be generated by means of the friction ring between the carrier structure and the bearing device, which is preferably sufficient in order to hold the armrest body in any intermediate positions between the resting position and the supporting position. In particular, the armrest body can be held in its resting position by a frictional connection.

In a further embodiment, the armrest arrangement has a resiliently deformable compensating device for compensating for axial play between the bearing device and the carrier structure, in particular wherein the compensating device is configured integrally on a fastening device for releasably holding the bearing device on the profiled shaft and/or on the carrier structure. Advantageously, therefore, axial play between the bearing device and the carrier structure can be minimized or even entirely eliminated.

In a further embodiment, the bearing device is held axially and radially on the profiled shaft by means of the compensating device, in particular by means of a pretensioning force generated by the compensating device. Advantageously, therefore, axial and radial play of the bearing device relative to the profiled shaft can be kept small or even entirely avoided by means of the compensating device.

In a further embodiment, the bearing device has a receiving opening which is complementary to the profiled shaft and into which the free end portion of the profiled shaft is releasably inserted along the longitudinal axis in order to connect the bearing device positively to the profiled shaft about the longitudinal axis. Advantageously, this results in a particularly robust armrest arrangement.

In a further embodiment, a bearing piece of the bearing device has, in particular, an integral pretensioning portion which is deformable by means of the profiled shaft for compensating for axial play between the profiled shaft and the bearing device by generating an axial pretensioning force. The pretensioning portion can be in contact with a front face of the profiled shaft. This promotes the arrangement of the bearing device on the profiled shaft without play.

For the subassembly, the aforementioned aspect of the invention is achieved by the carrier structure being held on the bearing device so as to be pivotably movable about the longitudinal axis, and by the bearing device being adapted to a free end portion of the profiled shaft with a rotationally asymmetrical, in particular polygonal, cross section and the bearing device being able to be positioned axially on the free end portion such that the bearing device can be positively connected to the profiled shaft about the longitudinal axis. The subassembly can be premounted. The subassembly according to the invention is provided for an armrest arrangement according to the invention, as described above. In particular, the supporting structure is not a constituent part of the subassembly. The subassembly can comprise all of the components of the armrest arrangement apart from the supporting device. The aforementioned advantages of the armrest arrangement according to the invention can be also transferred under this stipulation to the subassembly according to the invention for such an armrest arrangement.

Expediently the armrest arrangement can form a side armrest arrangement, wherein the aforementioned subassembly can be removed to one side from the supporting structure or from the profiled shaft or conversely can be axially positioned on the profiled shaft. Such a side armrest arrangement, in particular, is exclusively designed for mounting on one side of a vehicle seat structure, in particular in the form of a single seat.

For the vehicle seat structure, the aforementioned aspect of the invention is achieved by the vehicle seat structure being provided with an armrest arrangement according to the invention, as described above. The vehicle seat structure is provided for a use in a vehicle, in particular in a motor vehicle, preferably in a passenger motor vehicle. The vehicle seat structure comprises a structural part, the armrest body being pivotably movable relative thereto between its resting position and its supporting position. The supporting structure of the armrest arrangement can be fastened to the structural part. The structural part can be fixed to the vehicle. Preferably, the vehicle seat structure is configured as a single seat.

Further advantages and features of the invention are found in the claims and in the following description of a preferred exemplary embodiment of the invention which is shown with reference to the drawings. The same reference signs refer to components which are the same or similar or functionally the same.

It is to be understood that the features mentioned above and those to be explained in more detail below are not only able to be used in the specified combination but also in other combinations or individually without departing from the scope of the present invention.

### BRIEF DESCRIPTION OF THE DRAWINGS

FIG. 1 shows in a schematic perspective view an embodiment of a vehicle seat structure according to the invention with an armrest arrangement which is designed according to the invention and which has a subassembly designed according to the invention;

FIG. 2 shows in a schematic perspective exploded view the armrest arrangement according to FIG. 2; and

FIG. 3 shows in a schematic longitudinal section along a longitudinal axis the armrest arrangement according to FIGS. 1 and 2.

### DETAILED DESCRIPTION

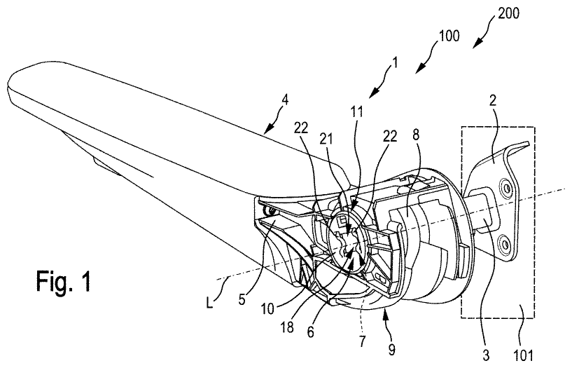

A vehicle 200 has a vehicle seat structure 100 according to FIG. 1. The vehicle 200 can be a motor vehicle, for example in the form of a passenger motor vehicle. The vehicle seat structure 100 can be in the form of a single seat, for example as a driver's seat or as a front passenger seat. An armrest arrangement 1 is arranged on at least one external flank of a backrest arrangement of the vehicle seat structure 100. The backrest arrangement can form a structural part 101 of the vehicle seat structure 100.

The armrest arrangement 1 has an armrest body 4 which is pivotably movable relative to the structural part 101 between a resting position and a supporting position. In its resting position, the armrest body 4 can run along an extent of the structural part 101, for example substantially in the direction of gravity. Accordingly, in its supporting position the armrest body 4 can run transversely to the extent of the structural part 101, for example at an angle, in particular perpendicularly, to the direction of gravity. In other words: the armrest body 4 can be folded up from its supporting position into its resting position, for example in order to enable a passenger of the vehicle 200 to take a seat on a seat surface of the vehicle seat structure 100. In the supporting position, the armrest body 4 can support an arm of the passenger.

The armrest arrangement 1 has a supporting structure 2. In a mounted state of the supporting structure 2, in which the supporting structure 2 is mounted, for example, on the structural part 101, the supporting structure 2 is fixed to the vehicle. Accordingly, the structural part 101 of the vehicle seat structure 100 can be fixed to the vehicle. The supporting structure 2 has a profiled shaft 3 which is fixed to the vehicle in the mounted state of the supporting structure 2. The already discussed armrest body 4 of the armrest arrangement 1 has a carrier structure 5. An upholstery element of the armrest arrangement 1 can be attached to the carrier structure 5.

The armrest arrangement 1 also has a bearing device 6. The armrest body 4 is mounted on the profiled shaft 3 by means of the bearing device 6. The armrest body 4 is mounted on the profiled shaft 3 such that the armrest body 4 is pivotably movable relative to the supporting structure 2 about a longitudinal axis L of the profiled shaft 3 between the resting position and the supporting position. The bearing device 6 can be releasably held on the carrier structure 5 axially and radially relative to the longitudinal axis L. The bearing device 3 can thus be substantially immovable relative to the carrier structure 5 along the longitudinal axis L and transversely to the longitudinal axis L. The carrier structure 5 is held on the bearing device 6 so as to be pivotably movable about the longitudinal axis L. A sliding contact can be present between the carrier structure 5 and the bearing device 6. The profiled shaft 3 has a free end portion 7. Opposite the free end portion 7, the profiled shaft 3 can be fastened to the structural part 101 by means of a flange of the supporting structure 2. The free end portion 7 of the profiled shaft 3 has a rotationally asymmetrical cross section. The cross section is oriented perpendicularly to the longitudinal axis L. The cross section can be configured to be polygonal. In the present case, the cross section is configured to be substantially square. “Substantially” refers to the fact that the polygonal cross section can be produced with rounded or chamfered corners. It goes without saying that other rotationally asymmetrical cross sections are also conceivable, for example elliptical or other non-circular cross sections. The rotationally asymmetrical cross section is configured, for example, to be non-circular. The bearing device 6 is axially positioned on the free end portion 7. The bearing device 6 is releasably and positively connected to the profiled shaft 3 about the longitudinal axis L. The bearing device 6 can be connected to the profiled shaft 3 so as to be fixed in terms of rotation. The bearing device 6 and the profiled shaft 3 can form a positive plug connection, a twisting of the bearing device 6 about the longitudinal axis L relative to the profiled shaft 3 being positively prevented thereby.

For example, the bearing device 6 can be premounted on the armrest body 4. The bearing device 6 can be premounted on the carrier structure 5. In a premounted state of the bearing device 6, the bearing device 6 can be positioned together with the armrest body 4 on the free end portion 7. Starting from the positioned state, the bearing device 6 together with the armrest body 4 can be removed again from the free end portion 7. In the premounted state, the bearing device 6 and the armrest body 4 thus form a subassembly according to the invention which can be attached in the premounted state to the supporting structure 2. The subassembly can then be removed again from the supporting structure 2, for example for maintenance purposes, without the subassembly having to be dismantled. In particular, such a mounting and/or dismantling of the assembled subassembly can be carried out both when the supporting structure 2 is mounted on the structural part 101 of the vehicle seat structure 100 and when the supporting structure 2 is not fastened to the vehicle seat structure 100.

In the present case, the bearing device 6 has a rotary stop element 8. The rotary stop element 8 is positively positioned on the free end portion 7 of the profiled shaft 3 about the longitudinal axis L. The armrest body 4 has a stop device 9. In the present case the stop device 9 is adjustable relative to the carrier structure 5. The stop device 9 bears against the rotary stop element 8 in the supporting position. Conversely, in the resting position the stop device 9 can be arranged spaced apart from the rotary stop element 8. The supporting position can be adjusted relative to the resting position by adjusting the stop device 9 relative to the carrier structure 5. In the present case, the stop device 9 has a claw-shaped region with two projections which flank the rotary stop element 8 on both sides along the longitudinal axis L. In the present case, the rotary stop element 8 has a main body from which a projection radially protrudes. This projection can form the actual stop for the supporting position. The projection can be in contact with a connecting portion between the two projections of the claw-shaped region when the armrest body 4 is in its supporting position.

The bearing device 4 has, for example, at least one bearing piece 10. The bearing piece 10 can be configured in a sleeve-shaped manner. The bearing piece 10 is positively positioned on the free end portion 7 of the profiled shaft 3 about the longitudinal axis L. The carrier structure 5 has for each bearing piece 2 a bearing opening 11 in which the bearing piece 10 is received in a rotationally movable manner relative to the carrier structure 5. A sliding contact can be configured between the bearing piece 10 and the bearing opening 11. The bearing piece 10 can have a radially protruding shoulder 12 which forms an axial stop for the carrier structure 5. The shoulder 12 can be configured to circulate in an annular manner with gaps or without gaps. In the present case, two bearing pieces 10 and two associated bearing openings 11 can be present. At least one of the bearing pieces 10 can be releasably fixed by means of a securing ring 23 axially to the carrier structure 5 or in the associated bearing opening 11.

The two bearing pieces 10 which are provided in the present embodiment are positively positioned in the longitudinal direction L on both sides of the rotary stop element 8 on the free end portion 7 of the profiled shaft 3 about the longitudinal axis L. At least one of the bearing pieces 10 and—alternatively or additionally—the rotary stop element 8 can have a positioning aid 13 for orienting the at least one bearing piece 10 and the rotary stop element 8 relative to one another. In the present case, on their front faces facing the rotary stop element 8 the two bearing pieces 10 have in each case at least one such positioning aid 13 in the form of a projection which is received in complementary recesses on the front faces of the rotary stop element 8. In this manner, a rotational orientation of the bearing pieces 10 and the rotary stop element 8 can be ensured, in particular before the bearing pieces 10 and the rotary stop element 8 are positioned on the free end portion 7 of the profiled shaft 3.

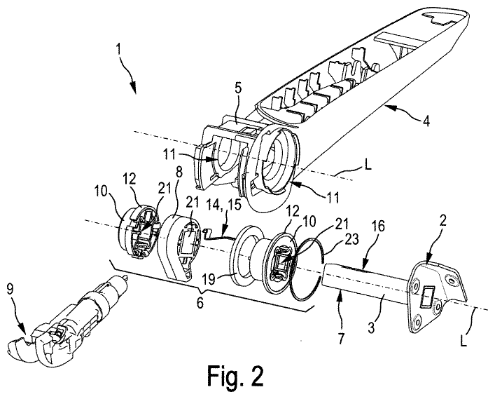

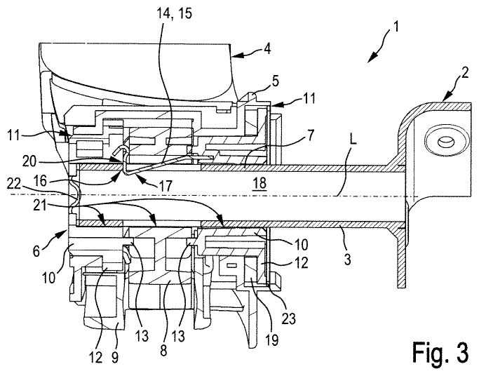

The carrier structure 5 can have a radial recess which is arranged between the two bearing openings 11 which are provided in the present case. The bearing piece 10, shown to the left in FIGS. 2 and 3, can be attached to the associated bearing opening 11 via this radial recess. The rotary stop element 8 can also be positioned on the carrier structure 5 via the radial recess. The bearing piece 10, shown to the right in FIGS. 2 and 3, is arranged from outside in the longitudinal direction L on the associated bearing opening 11 and then axially releasably fastened to the carrier structure 5 by means of a securing ring 23. With a corresponding arrangement of the bearing pieces 10 and the rotary stop element 8, i.e. in the aforementioned pre-mountable subassembly, the bearing pieces 10 and the rotary stop element 8 can be held by means of the positioning aids 13 in the correct orientation on the carrier structure 5 to be positioned on the profiled shaft 3.

In the present case, the armrest arrangement 1 has a fastening device 14, the bearing device 6 being releasably held thereby on the carrier structure 5 axially and radially relative to the longitudinal axis L. In the above-described arrangement, the bearing pieces 10 and the rotary stop element 8 can be releasably held on the carrier structure 5 by means of the fastening device 14. The bearing device 6 can also be axially releasably held on the profiled shaft 3 by means of the fastening device 14. In particular, the fastening device 14 for holding the bearing device 6 on the carrier structure 5 and for holding the bearing device 6 on the profiled shaft 3 are one and the same fastening device 14.

In the present case, the fastening device 14 is configured in the manner of a clip. The fastening device 14 has a resiliently deformable pretensioning element 15. The free end portion 7 of the profiled shaft 3 has an engagement contour 16. In the present case, the engagement contour 16 is configured as a through-passage, a profile interior 18 of the profiled shaft 3 being opened thereby toward the outside. The pretensioning element 15 has an engagement portion 17 which can be resiliently deflected transversely to the longitudinal axis L. The engagement portion 17 engages, in particular radially, into the engagement contour 16 in order to hold the bearing device 6 releasably on the profiled shaft 3 along the longitudinal axis L. For example, the engagement portion 17 engages into the engagement contour 16 in the manner of a snap hook. The engagement portion 17 can protrude through the engagement contour 16 into the profile interior 17 of the profiled shaft 3. The pretensioning element 17 can be fastened to one of the bearing pieces 10 at one end of the pretensioning element 17 which faces away from the engagement portion 17. For example, this end of the pretensioning element 17 is inserted into, in particular pressed into, a receiving recess of the relevant bearing piece 10 provided therefor. The engagement portion 17 is configured, for example, such that when the bearing device 6 is positioned on the free end portion 7 of the profiled shaft 3, the engagement portion 17 is radially deflected by the end portion 7 and, as soon as the engagement portion 17 overlaps the engagement contour 16, automatically springs back radially in order to engage in the engagement contour 16.

The profile interior 18 of the profiled shaft 3 is, for example, accessible on the front face along the longitudinal axis L so that a connection between the bearing device 6 and the profiled shaft 3 can be released from the outside via the profile interior 18. For example, the engagement portion 17 can be radially adjusted through an opening of the profiled shaft 3 on the front face by means of an elongated tool, for example by means of a screwdriver, in order to release the engagement of the engagement portion 17.

In the present case, the armrest arrangement also has a friction ring 19 which is arranged along the longitudinal axis L between the carrier structure 5 and the bearing device 6.

For example, the friction ring 19 is clamped between the carrier structure 5 and the bearing device 6, in particular in order to generate a defined friction between the carrier structure 5 and the bearing device 6. This clamping can be achieved by means of a resiliently deformable compensating device 20 of the armrest arrangement 1. The resiliently deformable compensating device 20 serves for compensating for axial play between the bearing device 6 and the carrier structure 5. As in the present case, the compensating device 20 can be configured integrally on the fastening device 14 for releasably holding the bearing device 6 on the profiled shaft 3 and/or on the carrier structure 5. In the present case, the compensating device 20 is designed in the manner of a wave spring which protrudes radially outwardly from the engagement portion 17. For example, the bearing device 6 is held axially and radially on the profiled shaft 3 by means of the compensating device 20, in particular by means of a pretensioning force generated by the compensating device 20. In the present case, this pretensioning force generated by the compensating device 20 ensures that the bearing piece 10, shown in FIGS. 2 and 3 to the left, is pushed with its radial projection 12 against the carrier structure 5 and opposite thereto the rotary stop element 8 is pushed against the bearing piece 10, shown in FIGS. 2 and 3 to the right. This right-hand bearing piece 10 in turn is axially supported by means of the securing ring 23. The positioning aids 13 can hold the rotary stop element 8 between the two bearing pieces 10 radially and in the correct rotational orientation. In this manner, after the engagement portion 17 has been actuated, the profiled shaft 3 can be removed from the bearing device 6 along the longitudinal axis L without the individual components of the bearing device 6 losing their connection, in particular the axial and radial fastening, to the carrier structure 5. The subassembly can thus remain in its assembled or premounted state.

In the present case, the bearing device 6 has a receiving opening 21 which is configured in a complementary manner to the profiled shaft 3. The two bearing pieces 10 and the rotary stop element 8 have in each case an axial portion of this receiving opening 21. These portions are arranged in common alignment with the longitudinal axis L. The free end portion 7 of the profiled shaft 3 is inserted along the longitudinal axis L, in particular releasably, into the receiving opening 21 in order to connect the bearing device 6 positively to the profiled shaft 3 about the longitudinal axis L.

For example, at least one bearing piece 10 of the bearing device 6 has, in particular, an integral pretensioning portion 22. This pretensioning portion 22 serves for compensating for axial play between the profiled shaft 3 and the bearing device 6. The pretensioning portion 22 can be deformed by means of the profiled shaft 3 for compensating for axial play by generating an axial pretensioning force. In the present case, the bearing piece 10, shown in FIGS. 2 and 3 to the left, is configured with such an integral pretensioning portion 22. The integral pretensioning portion 22 can ensure that the engagement contour 16 of the profiled shaft 3 is in contact with the compensating device 20 without play along the longitudinal axis L. The integral pretensioning portion 22 can be in contact with a front face of the free end portion 7 of the profiled shaft 3.

1. An armrest arrangement for a vehicle seat structure having a supporting structure fixed to the vehicle in a mounted state and having a profiled shaft fixed to the vehicle in a mounted state, an armrest body with a carrier structure, and a bearing device, the armrest body being mounted by the bearing device on the profiled shaft so as to be pivotably movable relative to the supporting structure about a longitudinal axis of the profiled shaft between a resting position and a supporting position, the carrier structure being held on the bearing device so as to be pivotably movable about the longitudinal axis, the profiled shaft having a free end portion with a rotationally asymmetrical cross section, and the bearing device is axially positioned on the free end portion such that the bearing device is positively connected to the profiled shaft about the longitudinal axis.

2. The armrest arrangement as claimed in claim 1, wherein the bearing device is premounted on the armrest body, in particular on the carrier structure, and in the premounted state the bearing device together with the armrest body is positioned on the free end portion or is removable from the free end portion.

3. The armrest arrangement as claimed in claim 1, wherein the bearing device has a rotary stop element is positively positioned on the free end portion of the profiled shaft about the longitudinal axis, and the armrest body has a stop device which is adjustable, in particular, relative to the carrier structure, wherein the stop device bears against the rotary stop element in the supporting position.

4. The armrest arrangement as claimed in claim 1, wherein the bearing device has at least one, in particular sleeve-shaped, bearing piece positively positioned on the free end portion of the profiled shaft about the longitudinal axis, and the carrier structure has for each bearing piece a bearing opening in which the bearing piece is received so as to be rotatably movable relative to the carrier structure, in particular wherein the bearing piece has a radially protruding shoulder forming an axial stop for the carrier structure.

5. The armrest arrangement as claimed in claim 4, wherein the bearing device includes two bearing pieces and a rotary stop element, the bearing pieces being disposed on respective opposite sides of the rotary stop element of the bearing device and being positively positioned on the free end portion of the profiled shaft so as to be fixed in terms of rotation, in particular wherein at least one of the bearing pieces and/or the rotary stop element has a positioning aid for orienting the at least one bearing piece and the rotary stop element relative to one another.

6. The armrest arrangement as claimed in claim 4, further including a fastening device, wherein the bearing device is releasably held on the carrier structure axially and radially relative to the longitudinal axis by the fastening device of the armrest arrangement and/or the bearing device is releasably held axially on the profiled shaft by the, in particular by the same, fastening device.

7. The armrest arrangement as claimed in claim 6, wherein the fastening device has a resiliently deformable pretensioning element, the pretensioning element having an engagement portion, the free end portion has an engagement contour and the engagement portion of the pretensioning element, which engagement portion is resiliently deflectable transversely to the longitudinal axis, engages in the engagement contour, in particular in the manner of a snap hook, in order to hold the bearing device releasably on the profiled shaft along the longitudinal axis, in particular wherein the engagement portion protrudes through the engagement contour into a profile interior of the profiled shaft.

8. The armrest arrangement as claimed in claim 6, wherein the profiled shaft has a profile interior accessible on a front face along the longitudinal axis, in particular in order to release a connection between the bearing device and the profiled shaft.

9. The armrest arrangement as claimed in claim 1, wherein the armrest arrangement has a friction ring arranged, in particular clamped, along the longitudinal axis between the carrier structure and the bearing device.

10. The armrest arrangement as claimed in claim 1, wherein the armrest arrangement includes a fastening device and a resiliently deformable compensating device for compensating for axial play between the bearing device and the carrier structure, in particular wherein the compensating device is configured integrally on the fastening device, the fastening device for releasably holding the bearing device on the profiled shaft and/or on the carrier structure.

11. The armrest arrangement as claimed in claim 10, wherein the bearing device is held axially and radially on the profiled shaft by the compensating device, in particular via a pretensioning force generated by the compensating device.

12. The armrest arrangement as claimed in claim 1, wherein the bearing device has a receiving opening complementary to the profiled shaft, the free end portion of the profiled shaft being inserted into the receiving opening along the longitudinal axis to connect the bearing device positively to the profiled shaft about the longitudinal axis.

13. The armrest arrangement as claimed in claim 1, wherein the bearing device has a bearing piece, the bearing piece having, in particular, an integral pretensioning portion deformable by the profiled shaft for compensating for axial play between the profiled shaft and the bearing device by generating an axial pretensioning force.

14. A subassembly for an armrest arrangement having a profiled shaft, the subassembly comprising:
an armrest body with a carrier structure; and
a bearing device, the armrest body being mounted by the bearing device on the profiled shaft so as to be pivotably movable about a longitudinal axis of the profiled shaft between a resting position and a supporting position,
the carrier structure being held on the bearing device so as to be pivotably movable about the longitudinal axis, and the bearing device is adapted to a free end portion of the profiled shaft with a rotationally asymmetrical, in particular polygonal, cross section and the bearing device can be positioned axially on the free end portion such that the bearing device can be positively connected to the profiled shaft about the longitudinal axis.

15. A vehicle seat structure, in particular for a vehicle, the vehicle seat structure comprising:
an armrest arrangement, the armrest arrangement comprising a supporting structure fixed to the vehicle in a mounted state and having a profiled shaft fixed to the vehicle in a mounted state, an armrest body with a carrier structure, and a bearing device, the armrest body being mounted by the bearing device on the profiled shaft so as to be pivotably movable relative to the supporting structure about a longitudinal axis of the profiled shaft between a resting position and a supporting position, the carrier structure being held on the bearing device so as to be pivotably movable about the longitudinal axis, the profiled shaft having a free end portion with a rotationally asymmetrical cross section, and the bearing device is axially positioned on the free end portion such that the bearing device is positively connected to the profiled shaft about the longitudinal axis; and
a structural part, the armrest body being pivotably movable relative to the structural part between the resting position and the supporting position.
